(19) United States
(12) Patent Application Publication
(10) Pub. No.: US 2026/0067879 A1
(43) Pub. Date: Mar. 5, 2026

(54) AUDIO SIGNAL FREQUENCY BAND EXTENSION METHOD AND APPARATUS, DEVICE, AND STORAGE MEDIUM

(71) Applicant: BEIJING XIAOMI MOBILE SOFTWARE CO., LTD., Beijing (CN)

(72) Inventors: Bin WANG, Beijing (CN); Xin WU, Beijing (CN); Weijie WANG, Beijing (CN)

(21) Appl. No.: 19/108,290

(22) PCT Filed: Sep. 5, 2022
(86) PCT No.: PCT/CN2022/117110

§ 371 Date: Mar. 3, 2025

(51) Int. Cl. H04W 72/0453

(52) U.S. Cl. CPC H04W 72/0453

(57) ABSTRACT

A method for extending a frequency band of an audio signal, which is performed by a decoding device and includes: receiving a bit stream sent by an encoding device, and obtaining a decoded audio frequency domain signal by decoding the bit stream; and in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, predicting a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

### CROSS-REFERENCE TO RELATED APPLICATIONS

The present application is a U.S. National Stage of International Application No. PCT/CN2022/117110, filed on Sep. 5, 2022, the content of which is incorporated herein by reference in its entirety for all purposes.

### TECHNICAL FIELD

The present disclosure relates to the field of mobile communication technology, and more particularly to a method/apparatus/device for extending a frequency band of an audio signal and a storage medium.

### BACKGROUND

In order to reduce resources occupied by an audio signal during a transmission in a communications network, a signal transmitter usually converts the audio signal from a time domain signal to a frequency domain signal before transmitting the audio signal, and then uses an encoding device to compress and encode the frequency domain signal before transmitting the frequency domain signal. After a signal receiver receives an encoded signal, it is necessary to first use a decoding device to perform a decoding operation to reconstruct an audio frequency domain signal, and then convert the reconstructed audio frequency domain signal into a time domain signal to obtain a reconstructed audio time domain signal.

### SUMMARY

In a first aspect, embodiments of the present disclosure provide a method for extending a frequency band of an audio signal, which is performed by a decoding device and includes: receiving a bit stream sent by an encoding device, and obtaining a decoded audio frequency domain signal by decoding the bit stream; and in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, predicting a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

In a second aspect, embodiments of the present disclosure provide a communication apparatus, which includes a processor and a memory having stored therein a computer program executable by the processor. The processor is configured to receive a bit stream sent by an encoding device, and obtain a decoded audio frequency domain signal by decoding the bit stream; and predict, in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

In a third aspect, embodiments of the present invention provide a non-transitory computer-readable storage medium for storing instructions used by the above network device. The instructions, when executed by a processor, cause the processor to perform: receiving a bit stream sent by an encoding device, and obtaining a decoded audio frequency domain signal by decoding the bit stream; and in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, predicting a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

### BRIEF DESCRIPTION OF THE DRAWINGS

The above and/or additional aspects and advantages of the present disclosure will become apparent and more readily appreciated from the following descriptions of embodiments made with reference to the drawings, in which:

FIG. 1a and FIG. 1b are distribution relationship diagrams between a bandwidth extension frequency band and a highest frequency point with a bit allocation according to embodiments of the present disclosure;

FIG. 1c is a schematic diagram of an architecture of a communication system according to an embodiment of the present disclosure;

FIG. 2 is a schematic flowchart of a method for extending a frequency band of an audio signal according to an embodiment of the present disclosure;

FIG. 3a is a schematic flowchart of a method for extending a frequency band of an audio signal according to an embodiment of the present disclosure;

FIG. 3b is a schematic block diagram of a frequency spectrum signal between a highest frequency point with a bit allocation and a highest frequency point of a preset bandwidth extension frequency band, filled based on n copies of a frequency spectrum signal within a predetermined frequency band range or a predetermined frequency point range in an audio frequency domain signal, according to an embodiment of the present disclosure;

FIG. 3c is a schematic block diagram of a frequency spectrum signal between a highest frequency point with a bit allocation and a highest frequency point of a preset bandwidth extension frequency band, filled based on n copies of a frequency spectrum signal within a predetermined frequency band range or a predetermined frequency point range in an audio frequency domain signal, according to an embodiment of the present disclosure;

FIG. 4a is a schematic flowchart of a method for extending a frequency band of an audio signal according to yet another embodiment of the present disclosure;

FIG. 4b is a schematic block diagram of a frequency spectrum signal between a highest frequency point with a bit allocation and a highest frequency point of a preset bandwidth extension frequency band, filled based on m copies of a frequency spectrum signal within a predetermined frequency band range or a predetermined frequency point range in an audio frequency domain signal, according to an embodiment of the present disclosure;

FIG. 4c is a schematic block diagram of a frequency spectrum signal between a highest frequency point with a bit allocation and a highest frequency point of a preset bandwidth extension frequency band, filled based on h copies of a frequency spectrum signal within a predetermined frequency band range or a predetermined frequency point range in an audio frequency domain signal, according to an embodiment of the present disclosure;

FIG. 5 is a schematic flowchart of a method for extending a frequency band of an audio signal according to yet another embodiment of the present disclosure;

FIG. 6 is a schematic flowchart of a method for extending a frequency band of an audio signal according to yet another embodiment of the present disclosure;

FIG. 7 is a schematic flowchart of a method for extending a frequency band of an audio signal according to yet another embodiment of the present disclosure;

FIG. 8 is a schematic block diagram of a communication apparatus according to an embodiment of the present disclosure;

FIG. 9 is a schematic block diagram of a communication apparatus according to an embodiment of the present disclosure; and FIG. 10 is a schematic block diagram of a chip according to an embodiment of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with embodiments of the present disclosure. Instead, they are merely examples of devices and methods consistent with some aspects of embodiments of the present disclosure as recited in the appended claims.

Terms used herein in embodiments of the present disclosure are only for the purpose of describing specific embodiments, but should not be construed to limit embodiments of the present disclosure. As used in embodiments of the present disclosure and the appended claims, “a/an” and “the” in singular forms are intended to include plural forms, unless clearly indicated in the context otherwise. It should also be understood that the term “and/or” used herein represents and contains any or all possible combinations of one or more associated listed items.

It should be understood that, although terms such as “first,” “second” and “third” may be used in embodiments of the present disclosure for describing various information, these information should not be limited by these terms. These terms are only used for distinguishing information of the same type from each other. For example, first information may also be referred to as second information, and similarly, the second information may also be referred to as the first information, without departing from the scope of embodiments of the present disclosure. As used herein, the term “if” may be construed to mean “when” or “upon” or “in response to determining” depending on the context.

Embodiments of the present disclosure will be described in detail below, and examples of embodiments are illustrated in the drawings. The same or similar elements are denoted by like reference numerals throughout the descriptions. Embodiments described herein with reference to drawings are explanatory, serve to explain the present disclosure, and cannot be construed to limit embodiments of the present disclosure.

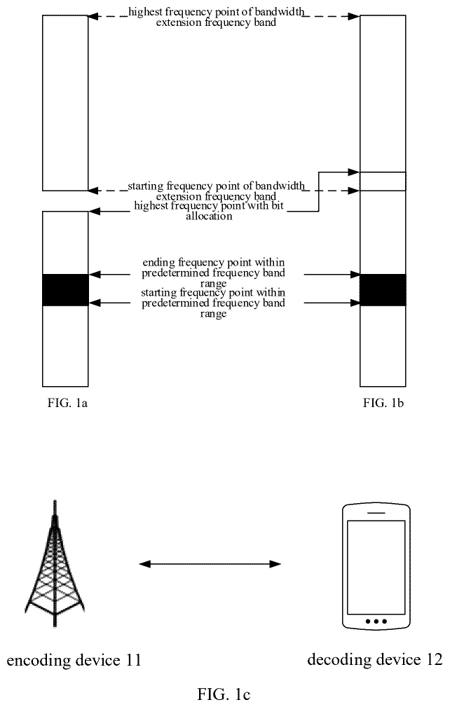

In the related art, in a process of decoding audio signals, the decoding device involves the following concepts, namely: a bandwidth extension frequency band (i.e., an extended high frequency band, specifically: a frequency band between the starting frequency point of the preset bandwidth extension frequency band and a highest frequency point of the preset bandwidth extension frequency band), a frequency point with a bit allocation (i.e., a frequency point corresponding to the encoded low frequency spectrum signal), and a highest frequency point with a bit allocation. The highest frequency point with the bit allocation is: a highest frequency point of the encoded low frequency spectrum signal. In other words, no low frequency spectrum signal is decoded from above the highest frequency point with the bit allocation. A frequency band above the highest frequency point with the bit allocation may be called a high frequency band, and a frequency band below the highest frequency point with the bit allocation may be called a low frequency band. Furthermore, there are two distribution manners between the bandwidth extension frequency band and the highest frequency point with the bit allocation described above. FIG. la and FIG. 1b are distribution relationship diagrams between a bandwidth extension frequency band and a highest frequency point with a bit allocation according to an embodiment of the present disclosure. As shown in FIG. 1a, a starting frequency point of the bandwidth extension frequency band may be higher than the highest frequency point with the bit allocation. Furthermore, as shown in FIG. 1b, a starting frequency point of the bandwidth extension frequency band may be lower than the highest frequency point with the bit allocation.

With regard to the above-mentioned FIG. 1a, since a decoding manner in the related art only predicts the high frequency spectrum signal corresponding to the bandwidth extension frequency band, the decoding manner in the related art will cause an area from the highest frequency point with the bit allocation to the starting frequency point of the bandwidth extension frequency band in FIG. 1a to have no corresponding frequency spectrum signal, which will cause an imbalanced high and low frequency energy within a frame, and further cause a technical problem of “mechanical feeling caused by spectrum holes”, thereby reducing a quality of reconstructed audio.

For ease of understanding, terms involved in the present disclosure are first introduced.

### 1. Frequency band

The frequency band is a range of one frequency or a width of a frequency spectrum, and a frequency point is one frequency point on the frequency band.

In order to better understand a method for extending a frequency band of an audio signal disclosed in embodiments of the present disclosure, a communication system to which embodiments of the present disclosure are applicable is firstly described below.

Embodiments of the present disclosure will be described in detail below, and examples of embodiments are illustrated in the drawings. The same or similar elements are denoted by like reference numerals throughout the descriptions. Embodiments described herein with reference to drawings are explanatory, serve to explain the present disclosure, and cannot be construed to limit embodiments of the present disclosure.

Referring to FIG. 1c, FIG. 1c is a schematic diagram of an architecture of a communication system according to an embodiment of the present disclosure. The communication system may include, but is not limited to, one encoding device and one decoding device. The above encoding device and decoding device may both be network devices or terminal devices. Furthermore, the number and forms of devices shown in FIG. 1c are only used as an example and do not constitute a limitation on embodiments of the present disclosure. The communication system may include two or more encoding devices and two or more decoding devices in practical applications. The communication system shown in FIG. 1c includes one encoding device 11 and one decoding device 12, and the encoding device 11 is a network device and the decoding device 12 is a terminal device.

It should be noted that the technical solutions of embodiments of the present disclosure may be applied to various communication systems, for example, a long term evolution (LTE) system, a 5th generation (5G) mobile communication system, a 5G new radio (NR) system, or other future new mobile communication systems.

The network device in embodiments of the present disclosure is an entity on a network side for sending or receiving signals. For example, the network device 11 may be an evolved NodeB (eNB), a transmission reception point (TRP), a next generation NodeB (gNB) in a NR system, a base station in other future mobile communication systems, or an access node in a wireless network (Wi-Fi™) system. The specific technology and specific device form adopted by the network device are not limited in embodiments of the present disclosure. The network device provided in embodiments of the present disclosure may be composed of a central unit (CU) and distributed units (DU). The CU may also be called a control unit. Using the CU-DU structure allows to split a protocol layer of the network device, such as the base station, so that some of functions of the protocol layer are centrally controlled in the CU, some or all of the remaining functions of the protocol layer are distributed in the DUs, and the CU centrally controls the DUs.

The terminal device in embodiments of the present disclosure is an entity on a user side for receiving or sending signals, such as a mobile phone. The terminal device may also be called a terminal, a user equipment (UE), a mobile station (MS), a mobile terminal (MT), and so on. The terminal device may be a device with a communication function, such as a car, a smart car, a mobile phone, a wearable device, a tablet (Pad), a computer with a wireless transceiving function, a virtual reality (VR) terminal device, an augmented reality (AR) terminal device, a wireless terminal device in an industrial control, a wireless terminal device in a self-driving, a wireless terminal device in a remote medical surgery, a wireless terminal device in a smart grid, a wireless terminal device in a transportation safety, a wireless terminal device in a smart city, a wireless terminal device in a smart home, etc. The specific technology and the specific device form adopted by the terminal device are not limited in embodiments of the present disclosure.

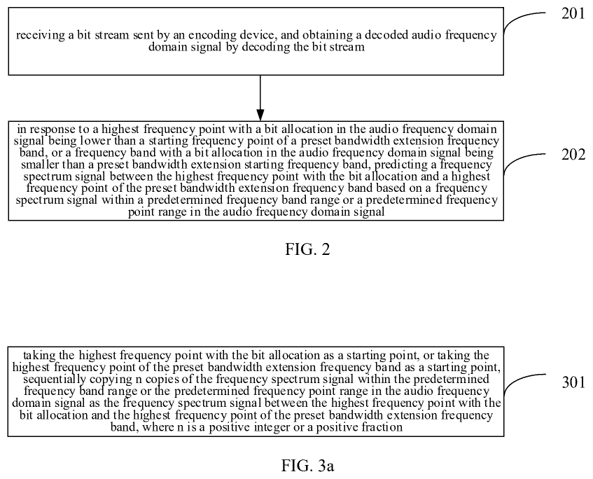

FIG. 2 is a schematic flowchart of a method for extending a frequency band of an audio signal according to an embodiment of the present disclosure, which is performed by a decoding device. As shown in FIG. 2, the method for extending the frequency band of the audio signal may include the following steps.

In step 201, a bit stream sent by an encoding device is received, and a decoded audio frequency domain signal is obtained by decoding the bit stream.

In an embodiment of the present disclosure, a specific execution manner of the step 201 is similar to the related art, and the present disclosure will not repeat it here.

Furthermore, referring to the background technology records, it can be known that the audio frequency domain signal obtained by decoding in this step is specifically a low frequency spectrum signal of the audio signal, that is, a frequency spectrum signal corresponding to a frequency band below a highest frequency point with a bit allocation in the above FIG. 1a and FIG. 1b.

It should be noted that the “frequency spectrum signal” mentioned in embodiments of the present disclosure may be a frequency band signal or a frequency point signal.

In step 202, in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, a frequency spectrum signal between the highest frequency point with the bit allocation and a highest frequency point of the preset bandwidth extension frequency band is predicted based on a frequency spectrum signal within a predetermined frequency band range or a predetermined frequency point range in the audio frequency domain signal.

In an embodiment of the present disclosure, the starting frequency point and the highest frequency point of the preset bandwidth extension frequency band may be predetermined by the decoding device based on an encoding rate (i.e., a total count of bits) of the encoding device and a frequency band range in the audio signal needing to be encoded. Specifically, in a case that the encoding rate is higher, the starting frequency point of the bandwidth extension frequency band may be set higher. For example, for an ultra-wideband signal, in a case that the encoding rate is 24 kbps, the starting frequency point of the preset bandwidth extension frequency band in the frequency domain signal may be 6.4 kHz (kilohertz); in a case that the encoding rate is 32 kbps, the starting frequency point of the preset bandwidth extension frequency band in the frequency domain signal may be 8 kHz. Furthermore, the highest frequency point of the bandwidth extension frequency band refers to a highest point or a specified frequency point of the frequency band required for outputting a signal. For a broadband signal, the highest frequency point of the preset bandwidth extension frequency band may be 7 kHz or 8 kHz, and for an ultra-wideband signal, the highest frequency point of the preset bandwidth extension frequency band may be 14 kHz or 16 kHz or other preset specific frequency points.

Furthermore, in an embodiment of the present disclosure, frequency points in the predetermined frequency band range or the predetermined frequency point range described above are all lower than the highest frequency point with the bit allocation. Referring to FIG. 1a and FIG. 1b above, the predetermined frequency band range is black portions of FIG. 1a and FIG. 1b, and the frequency points in the predetermined frequency band range are all lower than the highest frequency point with the bit allocation.

Further, in an embodiment of the present disclosure, the predetermined frequency band range or the predetermined frequency point range may be determined based on a signal type and the encoding rate of the audio signal. Specifically, for example, at a lower encoding rate, for a harmonic signal, a frequency band range or a frequency point range of a lower frequency spectrum signal with relatively better encoding in a low frequency spectrum signal may be selected as the predetermined frequency band range or the predetermined frequency point range; for a non-harmonic signal, a frequency band range or a frequency point range of a higher frequency spectrum signal with relatively poorer encoding in a low frequency spectrum signal may be selected as the predetermined frequency band range or the predetermined frequency point range; at a higher encoding rate, for a harmonic signal, a slightly higher frequency band or frequency point in a low frequency spectrum signal may be selected as the predetermined frequency band range or the predetermined frequency point range.

In addition, from the content of the above step 202, it can be seen that what is specifically predicted in the present disclosure is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio. A detailed introduction of “how the decoding device specifically predicts a predicted frequency spectrum signal corresponded between the highest frequency point with the bit allocation and the starting frequency point of the preset bandwidth extension frequency band” will be illustrated in subsequent embodiments.

In summary, in the method for extending the frequency band of the audio signal provided by the present disclosure, the decoding device may receive the bit stream sent by the encoding device, and obtains the decoded audio frequency domain signal by decoding the bit stream. Furthermore, in response to the highest frequency point with the bit allocation in the audio frequency domain signal being lower than the starting frequency point of the preset bandwidth extension frequency band, or the frequency band with the bit allocation in the audio frequency domain signal being smaller than the preset bandwidth extension starting frequency band, the decoding device predicts the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal. It can be seen from this that in the present disclosure, in a case that the highest frequency point with the bit allocation in the audio frequency domain signal is lower than the starting frequency point of the preset bandwidth extension frequency band, or in a case that the frequency band with the bit allocation in the audio frequency domain signal is smaller than the preset bandwidth extension starting frequency band, when predicting the frequency spectrum signal in the present disclosure, what is specifically predicted is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio.

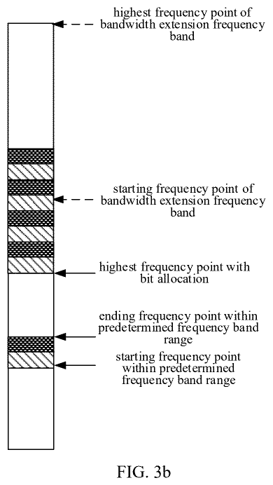

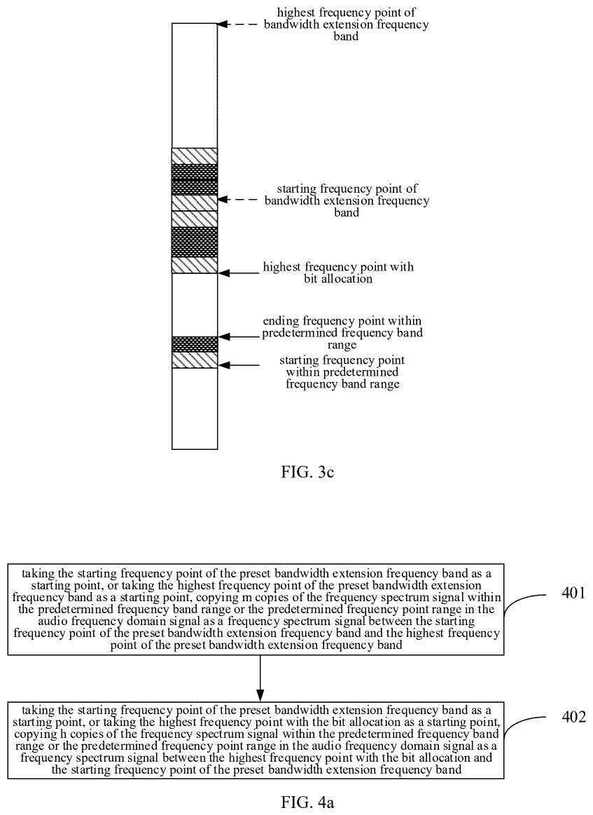

FIG. 3a is a schematic flowchart of a method for extending a frequency band of an audio signal according to an embodiment of the present disclosure, which is performed by a decoding device. As shown in FIG. 3a, the method for extending the frequency band of the audio signal may include a following step.

In step 301, taking the highest frequency point with the bit allocation as a starting point, or taking the highest frequency point of the preset bandwidth extension frequency band as a starting point, n copies of the frequency spectrum signal within the predetermined frequency band range or the predetermined frequency point range in the audio frequency domain signal are sequentially copied as the frequency spectrum signal between the highest frequency point with the bit allocation and the highest frequency point of the preset bandwidth extension frequency band.

In an embodiment of the present disclosure, n is a positive integer or a positive fraction. n may be a ratio of the number of frequency points between the highest frequency point with the bit allocation and the highest frequency point of the preset bandwidth extension frequency band to the number of frequency points within the predetermined frequency band range or the predetermined frequency point range.

Furthermore, in an embodiment of the present disclosure, a copying manner of the n copies of the frequency spectrum signal within the predetermined frequency band range or the predetermined frequency point range in the audio frequency domain signal described above includes any one of the following manners.

In a first manner, the n copies of the frequency spectrum signal within the predetermined frequency band or the predetermined frequency point range in the audio frequency domain signal are obtained by repeatedly copying in sequence the frequency spectrum signal within the predetermined frequency band or the predetermined frequency point range in the audio frequency domain signal.

That is, each copy of the frequency spectrum signal of the n copies of the frequency spectrum signal within the predetermined frequency band range or the predetermined frequency point range in the audio frequency domain signal is copied along a same direction (such as from a high frequency to a low frequency, or from a low frequency to a high frequency).

For example, FIG. 3b is a schematic block diagram of a frequency spectrum signal between a highest frequency point with a bit allocation and a highest frequency point of a preset bandwidth extension frequency band, filled based on n copies of a frequency spectrum signal within a predetermined frequency band range or a predetermined frequency point range in an audio frequency domain signal, according to an embodiment of the present disclosure. As shown in FIG. 3b, taking the highest frequency point with the bit allocation as the starting point, 4 copies of the frequency spectrum signal within the predetermined frequency band range or the predetermined frequency point range in the audio frequency domain signal are copied in a sequentially repeated copying manner as the frequency spectrum signal between the highest frequency point with the bit allocation and the highest frequency point of the preset bandwidth extension frequency band. Each copy of the frequency spectrum signal within the predetermined frequency band range or the predetermined frequency point range in the audio frequency domain signal is copied along “a direction from a low frequency to a high frequency”.

In a second manner, the n copies of the frequency spectrum signal within the predetermined frequency band or the predetermined frequency point range in the audio frequency domain signal are obtained by mirror-copying (or folded copying) multiple times the frequency spectrum signal within the predetermined frequency band or the predetermined frequency point range in the audio frequency domain signal.

That is, copying directions of adjacent copies of frequency spectrum signal in the n copies of the frequency spectrum signal within the predetermined frequency band range or the predetermined frequency point range in the audio frequency domain signal are different, such as: a copying direction of an i-th copy of the frequency spectrum signal is from a high frequency to a low frequency, and a copying direction of an i+1-th copy of the frequency spectrum signal is from a low frequency to a high frequency; or a copying direction of an i-th copy of the frequency spectrum signal is from a low frequency to a high frequency, and a copying direction of an i+1-th copy of the frequency spectrum signal is from a high frequency to a low frequency, where i=1, 2, 3, . . . , n.

For example, FIG. 3c is a schematic block diagram of a frequency spectrum signal between a highest frequency point with a bit allocation and a highest frequency point of a preset bandwidth extension frequency band, filled based on n copies of a frequency spectrum signal within a predetermined frequency band range or a predetermined frequency point range in an audio frequency domain signal, according to an embodiment of the present disclosure. As shown in FIG. 3c, taking the highest frequency point with the bit allocation as a starting point, 4 copies of the frequency spectrum signal within the predetermined frequency band range or the predetermined frequency point range in the audio frequency domain signal are copied in a mirror-copying manner as the frequency spectrum signal between the highest frequency point with the bit allocation and the highest frequency point of the preset bandwidth extension frequency band. A first copy of the frequency spectrum signal is copied along a direction of “a low frequency to a high frequency”, a second copy of the frequency spectrum signal is copied along a direction of “a high frequency to a low frequency”, a third copy of the frequency spectrum signal is copied along the direction of “the low frequency to the high frequency”, and a fourth copy of the frequency spectrum signal is copied along the direction of “the high frequency to the low frequency”.

It should be noted that, in an embodiment of the present disclosure, a same manner is specifically used between different frames to predict the frequency spectrum signal between the highest frequency point with the bit allocation and the highest frequency point of the preset bandwidth extension frequency band. For example, the method of embodiments corresponding to FIG. 3a may be used between different frames to predict the frequency spectrum signal between the highest frequency point with the bit allocation and the highest frequency point of the preset bandwidth extension frequency band, thereby ensuring that the frequency spectrum signal between frames is always consistent, ensuring a continuity of the audio signal between the frames, and ensuring a reconstructed audio quality of the audio signal.

In summary, in the method for extending the frequency band of the audio signal provided by the present disclosure, the decoding device may receive the bit stream sent by the encoding device, and obtains the decoded audio frequency domain signal by decoding the bit stream. Furthermore, in response to the highest frequency point with the bit allocation in the audio frequency domain signal being lower than the starting frequency point of the preset bandwidth extension frequency band, or the frequency band with the bit allocation in the audio frequency domain signal being smaller than the preset bandwidth extension starting frequency band, the decoding device predicts the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal. It can be seen from this that in the present disclosure, in a case that the highest frequency point with the bit allocation in the audio frequency domain signal is lower than the starting frequency point of the preset bandwidth extension frequency band, or in a case that the frequency band with the bit allocation in the audio frequency domain signal is smaller than the preset bandwidth extension starting frequency band, when predicting the frequency spectrum signal in the present disclosure, what is specifically predicted is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio.

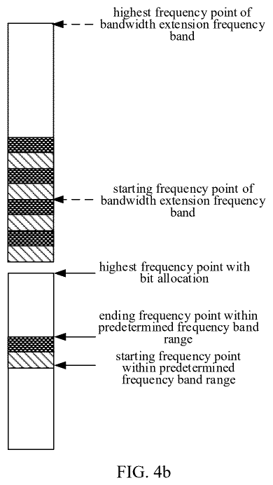

FIG. 4a is a schematic flowchart of a method for extending a frequency band of an audio signal according to an embodiment of the present disclosure, which is performed by a decoding device. As shown in FIG. 4a, the method for extending the frequency band of the audio signal may include the following steps.

In step 401, taking the starting frequency point of the preset bandwidth extension frequency band as a starting point, or taking the highest frequency point of the preset bandwidth extension frequency band as a starting point, m copies of the frequency spectrum signal within the predetermined frequency band range or the predetermined frequency point range in the audio frequency domain signal are copied as a frequency spectrum signal between the starting frequency point of the preset bandwidth extension frequency band and the highest frequency point of the preset bandwidth extension frequency band.

In an embodiment of the present disclosure, m is a positive integer or a positive fraction. m may be a ratio of a number of frequency points between the starting frequency point of the preset bandwidth extension frequency band and the highest frequency point of the preset bandwidth extension frequency band to a number of frequency points within the predetermined frequency band range or the predetermined frequency point range.

Furthermore, in an embodiment of the present disclosure, a copying manner of the m copies of the frequency spectrum signal within the predetermined frequency band range or the predetermined frequency point range in the audio frequency domain signal described above includes any one of the following manners.

In a first manner, the m copies of the frequency spectrum signal within the predetermined frequency band or the predetermined frequency point range in the audio frequency domain signal are obtained by repeatedly copying in sequence the frequency spectrum signal within the predetermined frequency band or the predetermined frequency point range in the audio frequency domain signal.

In a second manner, the m copies of the frequency spectrum signal within the predetermined frequency band or the predetermined frequency point range in the audio frequency domain signal are obtained by mirror-copying (or folded copying) multiple times the frequency spectrum signal within the predetermined frequency band or the predetermined frequency point range in the audio frequency domain signal.

In step 402, taking the starting frequency point of the preset bandwidth extension frequency band as a starting point, or taking the highest frequency point with the bit allocation as a starting point, h copies of the frequency spectrum signal within the predetermined frequency band range or the predetermined frequency point range in the audio frequency domain signal are copied as a frequency spectrum signal between the highest frequency point with the bit allocation and the starting frequency point of the preset bandwidth extension frequency band.

In an embodiment of the present disclosure, h is the positive integer or the positive fraction. h may be a ratio of a number of frequency points between the highest frequency point with the bit allocation and the starting frequency point of the preset bandwidth extension frequency band to a number of frequency points within the predetermined frequency band range or the predetermined frequency point range.

Furthermore, in an embodiment of the present disclosure, a copying manner of the h copies of the frequency spectrum signal within the predetermined frequency band range or the predetermined frequency point range in the audio frequency domain signal described above includes any one of the following manners.

In a first manner, the h copies of the frequency spectrum signal within the predetermined frequency band or the predetermined frequency point range in the audio frequency domain signal are obtained by repeatedly copying in sequence the frequency spectrum signal within the predetermined frequency band or the predetermined frequency point range in the audio frequency domain signal.

In a second manner, the h copies of the frequency spectrum signal within the predetermined frequency band or the predetermined frequency point range in the audio frequency domain signal are obtained by mirror-copying (or folded copying) multiple times the frequency spectrum signal within the predetermined frequency band or the predetermined frequency point range in the audio frequency domain signal.

For detailed introduction of the steps 401 to 402, reference may be made to the above description of embodiments.

Furthermore, it should be noted that, in an embodiment of the present disclosure, the copying manner of the m copies of the frequency spectrum signal within the predetermined frequency band range or the predetermined frequency point range in the audio frequency domain signal is consistent with the copying manner of the h copies of the frequency spectrum signal within the predetermined frequency band range or the predetermined frequency point range in the audio frequency domain signal; that is, the first manner (i.e., repeatedly copying in sequence) may be both used to copy and obtain the m copies of the frequency spectrum signal and the h copies of the frequency spectrum signal, or the second manner (i.e., mirror-copying multiple times) may be both used to copy and obtain the m copies of the frequency spectrum signal and the h copies of the frequency spectrum signal.

In an embodiment of the present disclosure, with respect to a use of a sequential copying manner, in a case of filling a frequency band between the starting frequency point of the preset bandwidth extension frequency band and the highest frequency point of the preset bandwidth extension frequency band, and filling a frequency band between the highest frequency point with the bit allocation and the starting frequency point of the preset bandwidth extension frequency band, filling directions of the two frequency bands are the same, such as the filling starts from the starting frequency point of the preset bandwidth extension frequency band as the starting point when filling the frequency band between the starting frequency point of the preset bandwidth extension frequency band and the highest frequency point of the preset bandwidth extension frequency band, and the filling starts from the highest frequency point with the bit allocation as the starting point when filling the frequency band between the highest frequency point with the bit allocation and the starting frequency point of the preset bandwidth extension frequency band, then a copying direction of the m copies of the frequency spectrum signal within the predetermined frequency band range or the predetermined frequency point range in the audio frequency domain signal described above should be the same as a copying direction of the h copies of the frequency spectrum signal within the predetermined frequency band range or the predetermined frequency point range in the audio frequency domain signal described above. For example, the copying direction of the m copies of the frequency spectrum signal within the predetermined frequency band range or the predetermined frequency point range in the audio frequency domain signal may be from the high frequency to the low frequency; and the copying direction of the h copies of the frequency spectrum signal within the predetermined frequency band range or the predetermined frequency point range in the audio frequency domain signal may also be from the high frequency to the low frequency.

In another embodiment of the present disclosure, with respect to a use of a sequential copying manner, in a case of filling a frequency band between the starting frequency point of the preset bandwidth extension frequency band and the highest frequency point of the preset bandwidth extension frequency band, and filling a frequency band between the highest frequency point with the bit allocation and the starting frequency point of the preset bandwidth extension frequency band, filling directions of the two frequency bands are different, such as the filling starts from the starting frequency point of the preset bandwidth extension frequency band as the starting point when filling the frequency band between the starting frequency point of the preset bandwidth extension frequency band and the highest frequency point of the preset bandwidth extension frequency band, and the filling starts from the starting frequency point of the preset bandwidth extension frequency band as the starting point when filling the frequency band between the highest frequency point with the bit allocation and the starting frequency point of the preset bandwidth extension frequency band, then a copying direction of the m copies of the frequency spectrum signal within the predetermined frequency band range or the predetermined frequency point range in the audio frequency domain signal described above should be opposite to a copying direction of the h copies of the frequency spectrum signal within the predetermined frequency band range or the predetermined frequency point range in the audio frequency domain signal described above. For example, the copying direction of the m copies of the frequency spectrum signal within the predetermined frequency band range or the predetermined frequency point range in the audio frequency domain signal may be from the high frequency to the low frequency; and the copying direction of the h copies of the frequency spectrum signal within the predetermined frequency band range or the predetermined frequency point range in the audio frequency domain signal may be from the low frequency to the high frequency.

For example, FIG. 4b is a schematic block diagram of a frequency spectrum signal between a highest frequency point with a bit allocation and a highest frequency point of a preset bandwidth extension frequency band, filled based on m copies of a frequency spectrum signal within a predetermined frequency band range or a predetermined frequency point range in an audio frequency domain signal, according to an embodiment of the present disclosure. As shown in FIG. 4b, for one frequency band from “the starting frequency point of the preset bandwidth extension frequency band” to “the highest frequency point of the preset bandwidth extension frequency band”, taking “the starting frequency point of the preset bandwidth extension frequency band” as the starting point, 2 copies of the frequency spectrum signal within the predetermined frequency band range or the predetermined frequency point range in the audio frequency domain signal are copied in a sequentially repeated copying manner as the frequency spectrum signal between the starting frequency point of the preset bandwidth extension frequency band and the highest frequency point of the preset bandwidth extension frequency band. A copying direction of each copy of the frequency spectrum signal is from the low frequency to the high frequency.

Furthermore, accordingly, as shown in FIG. 4b, for one frequency band from “the highest frequency point with the bit allocation” to “the starting frequency point of the preset bandwidth extension frequency band”, taking “the starting frequency point of the preset bandwidth extension frequency band” as the starting point, 2 copies of the frequency spectrum signal within the predetermined frequency band range or the predetermined frequency point range in the audio frequency domain signal are copied in a sequentially repeated copying manner as the frequency spectrum signal between the starting frequency point of the preset bandwidth extension frequency band and the highest frequency point of the preset bandwidth extension frequency band. A copying direction of each copy of the frequency spectrum signal is from the high frequency to the low frequency.

As a further example, FIG. 4c is a schematic block diagram of a frequency spectrum signal between a highest frequency point with a bit allocation and a highest frequency point of a preset bandwidth extension frequency band, filled based on h copies of a frequency spectrum signal within a predetermined frequency band range or a predetermined frequency point range in an audio frequency domain signal, according to an embodiment of the present disclosure. As shown in FIG. 4c, for one frequency band from “the starting frequency point of the preset bandwidth extension frequency band” to “the highest frequency point of the preset bandwidth extension frequency band”, taking “the starting frequency point of the preset bandwidth extension frequency band” as the starting point, 2 copies of the frequency spectrum signal within the predetermined frequency band range or the predetermined frequency point range in the audio frequency domain signal are copied in a mirror-copying manner as the frequency spectrum signal between the starting frequency point of the preset bandwidth extension frequency band and the highest frequency point of the preset bandwidth extension frequency band. A copying direction of a first copy of the frequency spectrum signal is from the low frequency to the high frequency, and a copying direction of a second copy of the frequency spectrum signal is from the high frequency to the low frequency.

Furthermore, accordingly, as shown in FIG. 4c, for one frequency band from “the highest frequency point with the bit allocation” to “the starting frequency point of the preset bandwidth extension frequency band”, taking “the starting frequency point of the preset bandwidth extension frequency band” as the starting point, 2 copies of the frequency spectrum signals within the predetermined frequency band range or the predetermined frequency point range in the audio frequency domain signal are copied in a mirror-copying manner as the frequency spectrum signal between the starting frequency point of the preset bandwidth extension frequency band and the highest frequency point of the preset bandwidth extension frequency band. A copying direction of a first copy of the frequency spectrum signal is from the low frequency to the high frequency, and a copying direction of a second copy of the frequency spectrum signal is from the high frequency to the low frequency.

It should be noted that, in an embodiment of the present disclosure, a same manner is specifically used between different frames to predict the frequency spectrum signal between the highest frequency point with the bit allocation and the highest frequency point of the preset bandwidth extension frequency band. For example, the method of embodiments corresponding to FIG. 4a may be used between different frames to predict the frequency spectrum signal between the highest frequency point with the bit allocation and the highest frequency point of the preset bandwidth extension frequency band, thereby ensuring that the frequency spectrum signal between frames is always consistent, ensuring a continuity of the audio signal between the frames, and ensuring a reconstructed audio quality of the audio signal.

In summary, in the method for extending the frequency band of the audio signal provided by the present disclosure, the decoding device may receive the bit stream sent by the encoding device, and obtains the decoded audio frequency domain signal by decoding the bit stream. Furthermore, in response to the highest frequency point with the bit allocation in the audio frequency domain signal being lower than the starting frequency point of the preset bandwidth extension frequency band, or the frequency band with the bit allocation in the audio frequency domain signal being smaller than the preset bandwidth extension starting frequency band, the decoding device predicts the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal. It can be seen from this that in the present disclosure, in a case that the highest frequency point with the bit allocation in the audio frequency domain signal is lower than the starting frequency point of the preset bandwidth extension frequency band, or in a case that the frequency band with the bit allocation in the audio frequency domain signal is smaller than the preset bandwidth extension starting frequency band, when predicting the frequency spectrum signal in the present disclosure, what is specifically predicted is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio.

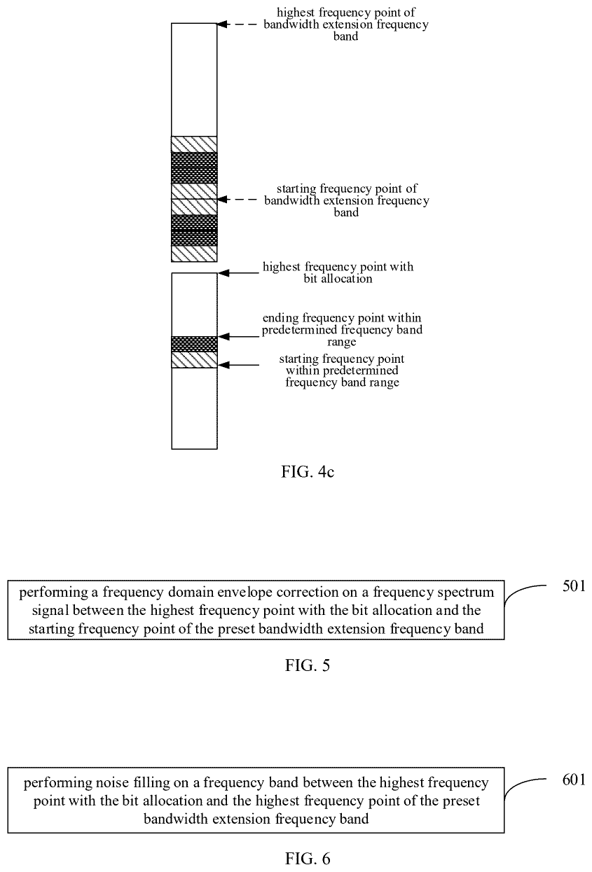

FIG. 5 is a schematic flowchart of a method for extending a frequency band of an audio signal according to an embodiment of the present disclosure, which is performed by a decoding device. As shown in FIG. 5, the method for extending the frequency band of the audio signal may include a following step.

In step 501, a frequency domain envelope correction on a frequency spectrum signal between the highest frequency point with the bit allocation and the starting frequency point of the preset bandwidth extension frequency band is performed.

In an embodiment of the present disclosure, a manner for performing the frequency domain envelope correction on the frequency spectrum signal between the highest frequency point with the bit allocation and the starting frequency point of the preset bandwidth extension frequency band may include any one of the following manners.

In a first manner, a frequency domain envelope value of a frequency spectrum signal between the highest frequency point with the bit allocation and an intermediate frequency point between the highest frequency point with the bit allocation and the starting frequency point of the preset bandwidth extension frequency band is corrected based on a frequency domain envelope value of a frequency spectrum signal between a first frequency point and the highest frequency point with the bit allocation; and a frequency domain envelope value of a frequency spectrum signal between the intermediate frequency point and the starting frequency point of the preset bandwidth extension frequency band is corrected based on a frequency domain envelope value of a frequency spectrum signal between the starting frequency point of the preset bandwidth extension frequency band and a second frequency point.

Specifically, in an embodiment of the present disclosure, the first frequency point is: W1−0.5×Wx; W1 represents the highest frequency point with the bit allocation, and Wx represents a frequency bandwidth between the highest frequency point with the bit allocation and the starting frequency point of the preset bandwidth extension frequency band; the second frequency point is: W2+0.5×Wx; and W2 represents the starting frequency point of the preset bandwidth extension frequency band.

Furthermore, in an embodiment of the present disclosure, the above “correcting the frequency domain envelope value of the frequency spectrum signal between the highest frequency point with the bit allocation and the intermediate frequency point between the highest frequency point with the bit allocation and the starting frequency point of the preset bandwidth extension frequency band based on the frequency domain envelope value of the frequency spectrum signal between the first frequency point and the highest frequency point with the bit allocation” may specifically include: making the frequency domain envelope value of the frequency spectrum signal between the highest frequency point with the bit allocation and the intermediate frequency point equal to the frequency domain envelope value of the frequency spectrum signal between the first frequency point and the highest frequency point with the bit allocation; or making a changing trend of the frequency domain envelope value of the frequency spectrum signal between the highest frequency point with the bit allocation and the intermediate frequency point equal to a changing trend of the frequency domain envelope value of the frequency spectrum signal between the first frequency point and the highest frequency point with the bit allocation.

Furthermore, the above “correcting the frequency domain envelope value of the frequency spectrum signal between the intermediate frequency point and the starting frequency point of the preset bandwidth extension frequency band based on the frequency domain envelope value of the frequency spectrum signal between the starting frequency point of the preset bandwidth extension frequency band and the second frequency point” may include: making the frequency domain envelope value of the frequency spectrum signal between the highest frequency point with the bit allocation and the intermediate frequency point equal to the frequency domain envelope value of the frequency spectrum signal between the starting frequency point of the preset bandwidth extension frequency band and the second frequency point; or making a changing trend of the frequency domain envelope value of the frequency spectrum signal between the highest frequency point with the bit allocation and the intermediate frequency point equal to a changing trend of the frequency domain envelope value of the frequency spectrum signal between the starting frequency point of the preset bandwidth extension frequency band and the second frequency point.

In a second manner, a frequency domain envelope value of the frequency spectrum signal between the highest frequency point with the bit allocation and the starting frequency point of the preset bandwidth extension frequency band is corrected based on a frequency domain envelope value of a frequency spectrum signal between a third frequency point and the highest frequency point with the bit allocation.

The third frequency point may be: W1−Wx.

Furthermore, the above correction of the frequency domain envelope value of the frequency spectrum signal between the highest frequency point with the bit allocation and the starting frequency point of the preset bandwidth extension frequency band based on the frequency domain envelope value of the frequency spectrum signal between the third frequency point and the highest frequency point with the bit allocation may specifically include: making the frequency domain envelope value of the frequency spectrum signal between the highest frequency point with the bit allocation and the starting frequency point of the preset bandwidth extension frequency band equal to the frequency domain envelope value of the frequency spectrum signal between the third frequency point and the highest frequency point with the bit allocation; or making a changing trend of the frequency domain envelope value of the frequency spectrum signal between the highest frequency point with the bit allocation and the starting frequency point of the preset bandwidth extension frequency band equal to a changing trend of the frequency domain envelope value of the frequency spectrum signal between the third frequency point and the highest frequency point with the bit allocation.

In addition, a frequency domain envelope value of a frequency band or a frequency point near the starting frequency point of the preset bandwidth extension frequency band may be corrected based on a frequency domain envelope value of the starting frequency point of the preset bandwidth extension frequency band, to ensure that a frequency domain envelope value of a frequency band or a frequency point smaller than the starting frequency point of the preset bandwidth extension frequency band remains continuous with the frequency domain envelope value of the starting frequency point of the preset bandwidth extension frequency band.

In a third manner, a frequency domain envelope value of the frequency spectrum signal between the highest frequency point with the bit allocation and the starting frequency point of the preset bandwidth extension frequency is corrected based on a frequency domain envelope value of a frequency spectrum signal between the starting frequency point of the preset bandwidth extension frequency band and a fourth frequency point.

The fourth frequency point is: W2+Wx.

Furthermore, the above correction of the frequency domain envelope value of the frequency spectrum signal between the highest frequency point with the bit allocation and the starting frequency point of the preset bandwidth extension frequency band based on the frequency domain envelope value of the frequency spectrum signal between the starting frequency point of the preset bandwidth extension frequency band and the fourth frequency point may specifically include: making the frequency domain envelope value of the frequency spectrum signal between the highest frequency point with the bit allocation and the starting frequency point of the preset bandwidth extension frequency band equal to the frequency domain envelope value of the frequency spectrum signal between the starting frequency point of the preset bandwidth extension frequency band and the fourth frequency point; or making a changing trend of the frequency domain envelope value of the frequency spectrum signal between the highest frequency point with the bit allocation and the starting frequency point of the preset bandwidth extension frequency band equal to a changing trend of the frequency domain envelope value of the frequency spectrum signal between the starting frequency point of the preset bandwidth extension frequency band and the fourth frequency point.

In addition, a frequency domain envelope value of a frequency band or a frequency point near the highest frequency point with the bit allocation may be corrected based on a frequency domain envelope value of the highest frequency point with the bit allocation, to ensure that a frequency domain envelope value of a frequency band or a frequency point greater than the highest frequency point with the bit allocation remains continuous with the frequency domain envelope value of the highest frequency point with the bit allocation.

It should be noted that the frequency domain envelope value of the frequency spectrum signal between the first frequency point and the highest frequency point with the bit allocation, the frequency domain envelope value of the frequency spectrum signal between the starting frequency point of the preset bandwidth extension frequency band and the second frequency point, the frequency domain envelope value of the frequency spectrum signal between the third frequency point and the highest frequency point with the bit allocation, and the frequency domain envelope value of the frequency spectrum signal between the starting frequency point of the preset bandwidth extension frequency band and the fourth frequency point may all be obtained by the decoding device by decoding the bit stream it receives.

From the above content, it can be seen that in the present disclosure, after filling the frequency spectrum signal between the highest frequency point with the bit allocation and the highest frequency point of the preset bandwidth extension frequency band, the frequency spectrum signal between the highest frequency point with the bit allocation and the starting frequency point of the preset bandwidth extension frequency band may also be subjected to the frequency domain envelope correction, to ensure a continuity of the frequency domain envelope value of the frequency spectrum signal between the highest frequency point with the bit allocation and the starting frequency point of the preset bandwidth extension frequency band, and also ensure a continuity of the frequency domain envelope value of the frequency band or the frequency point less than the starting frequency point of the preset bandwidth extension frequency band and the frequency domain envelope value of the starting frequency point of the preset bandwidth extension frequency band, and ensure a continuity of the frequency domain envelope value of the frequency band or the frequency point greater than the highest frequency point with the bit allocation and the frequency domain envelope value of the highest frequency point with the bit allocation, thereby ensuring a continuity of a subsequently reconstructed audio signal, solving a mechanical feeling problem caused by spectrum holes, and ensuring a reconstructed audio quality of the audio signal.

In summary, in the method for extending the frequency band of the audio signal provided by the present disclosure, the decoding device may receive the bit stream sent by the encoding device, and obtains the decoded audio frequency domain signal by decoding the bit stream. Furthermore, in response to the highest frequency point with the bit allocation in the audio frequency domain signal being lower than the starting frequency point of the preset bandwidth extension frequency band, or the frequency band with the bit allocation in the audio frequency domain signal being smaller than the preset bandwidth extension starting frequency band, the decoding device predicts the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal. It can be seen from this that in the present disclosure, in a case that the highest frequency point with the bit allocation in the audio frequency domain signal is lower than the starting frequency point of the preset bandwidth extension frequency band, or in a case that the frequency band with the bit allocation in the audio frequency domain signal is smaller than the preset bandwidth extension starting frequency band, when predicting the frequency spectrum signal in the present disclosure, what is specifically predicted is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio.

FIG. 6 is a schematic flowchart of a method for extending a frequency band of an audio signal according to an embodiment of the present disclosure, which is performed by a decoding device. As shown in FIG. 6, the method for extending the frequency band of the audio signal may include a following step.

In step 601, noise filling is performed on a frequency band between the highest frequency point with the bit allocation and the highest frequency point of the preset bandwidth extension frequency band.

In summary, in the method for extending the frequency band of the audio signal provided by the present disclosure, the decoding device may receive the bit stream sent by the encoding device, and obtains the decoded audio frequency domain signal by decoding the bit stream. Furthermore, in response to the highest frequency point with the bit allocation in the audio frequency domain signal being lower than the starting frequency point of the preset bandwidth extension frequency band, or the frequency band with the bit allocation in the audio frequency domain signal being smaller than the preset bandwidth extension starting frequency band, the decoding device predicts the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal. It can be seen from this that in the present disclosure, in a case that the highest frequency point with the bit allocation in the audio frequency domain signal is lower than the starting frequency point of the preset bandwidth extension frequency band, or in a case that the frequency band with the bit allocation in the audio frequency domain signal is smaller than the preset bandwidth extension starting frequency band, when predicting the frequency spectrum signal in the present disclosure, what is specifically predicted is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio.

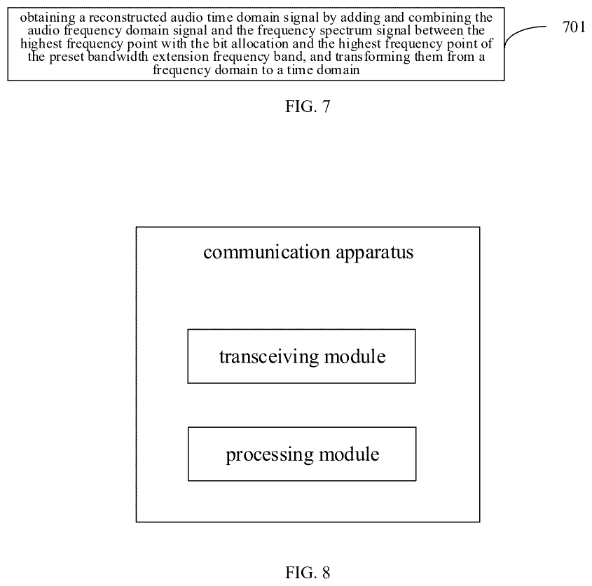

FIG. 7 is a schematic flowchart of a method for extending a frequency band of an audio signal according to an embodiment of the present disclosure, which is performed by a decoding device. As shown in FIG. 7, the method for extending the frequency band of the audio signal may include a following step.

In step 701, a reconstructed audio time domain signal is obtained by adding and combining the audio frequency domain signal and the frequency spectrum signal between the highest frequency point with the bit allocation and the highest frequency point of the preset bandwidth extension frequency band, and transforming them from a frequency domain to a time domain.

In summary, in the method for extending the frequency band of the audio signal provided by the present disclosure, the decoding device may receive the bit stream sent by the encoding device, and obtains the decoded audio frequency domain signal by decoding the bit stream. Furthermore, in response to the highest frequency point with the bit allocation in the audio frequency domain signal being lower than the starting frequency point of the preset bandwidth extension frequency band, or the frequency band with the bit allocation in the audio frequency domain signal being smaller than the preset bandwidth extension starting frequency band, the decoding device predicts the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal. It can be seen from this that in the present disclosure, in a case that the highest frequency point with the bit allocation in the audio frequency domain signal is lower than the starting frequency point of the preset bandwidth extension frequency band, or in a case that the frequency band with the bit allocation in the audio frequency domain signal is smaller than the preset bandwidth extension starting frequency band, when predicting the frequency spectrum signal in the present disclosure, what is specifically predicted is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio.

FIG. 8 is a schematic block diagram of a communication apparatus according to an embodiment of the present disclosure. As shown in FIG. 8, the apparatus may include: a transceiving module configured to receive a bit stream sent by an encoding device, and obtain a decoded audio frequency domain signal by decoding the bit stream; a processing module configured to predict, in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

In summary, in the communication apparatus provided in embodiments of the present disclosure, the decoding device may receive the bit stream sent by the encoding device, and obtains the decoded audio frequency domain signal by decoding the bit stream. Furthermore, in response to the highest frequency point with the bit allocation in the audio frequency domain signal being lower than the starting frequency point of the preset bandwidth extension frequency band, or the frequency band with the bit allocation in the audio frequency domain signal being smaller than the preset bandwidth extension starting frequency band, the decoding device predicts the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal. It can be seen from this that in the present disclosure, in a case that the highest frequency point with the bit allocation in the audio frequency domain signal is lower than the starting frequency point of the preset bandwidth extension frequency band, or in a case that the frequency band with the bit allocation in the audio frequency domain signal is smaller than the preset bandwidth extension starting frequency band, when predicting the frequency spectrum signal in the present disclosure, what is specifically predicted is the frequency spectrum signal between the highest frequency point with the bit allocation and the highest frequency point of the preset bandwidth extension frequency band, rather than only predicting a frequency spectrum signal of the bandwidth extension frequency band, which may result in a predicted frequency spectrum signal corresponded between the highest frequency point with the bit allocation and the starting frequency point of the preset bandwidth extension frequency band, and avoid a situation where “no frequency spectrum signal between the highest frequency point with the bit allocation and the starting frequency point of the preset bandwidth extension frequency band is provided”, thereby ensuring a balanced high and low frequency energy within a frame, and avoiding a mechanical feeling caused by spectrum holes, thereby improving a quality of a reconstructed audio.

In an embodiment of the present disclosure, the apparatus is further configured to: determine the starting frequency point and the highest frequency point of the preset bandwidth extension frequency band based on an encoding rate of the encoding device and a frequency band range in the audio signal needing to be encoded.

In an embodiment of the present disclosure, frequency points in the predetermined frequency band range or the predetermined frequency point range are all lower than the highest frequency point with the bit allocation.

In an embodiment of the present disclosure, the processing module is further configured to: taking the highest frequency point with the bit allocation as a starting point, or taking the highest frequency point of the preset bandwidth extension frequency band as a starting point, sequentially obtain n copies of the frequency spectrum signal within the predetermined frequency band range or the predetermined frequency point range in the audio frequency domain signal as the frequency spectrum signal between the highest frequency point with the bit allocation and the highest frequency point of the preset bandwidth extension frequency band, where n is a positive integer or a positive fraction.

In an embodiment of the present disclosure, a copying manner of the n copies of the frequency spectrum signal within the predetermined frequency band range or the predetermined frequency point range in the audio frequency domain signal includes: obtaining the n copies of the frequency spectrum signal within the predetermined frequency band range or the predetermined frequency point range in the audio frequency domain signal by repeatedly copying in sequence the frequency spectrum signal within the predetermined frequency band range or the predetermined frequency point range in the audio frequency domain signal; or obtaining the n copies of the frequency spectrum signal within the predetermined frequency band range or the predetermined frequency point range in the audio frequency domain signal by mirror-copying multiple times the frequency spectrum signal within the predetermined frequency band range or the predetermined frequency point range in the audio frequency domain signal.

In an embodiment of the present disclosure, the processing module is further configured to: taking the starting frequency point of the preset bandwidth extension frequency band as a starting point, or taking the highest frequency point of the preset bandwidth extension frequency band as a starting point, obtain m copies of the frequency spectrum signal within the predetermined frequency band range or the predetermined frequency point range in the audio frequency domain signal as a frequency spectrum signal between the starting frequency point of the preset bandwidth extension frequency band and the highest frequency point of the preset bandwidth extension frequency band, where m is a positive integer or a positive fraction; and taking the starting frequency point of the preset bandwidth extension frequency band as a starting point, or taking the highest frequency point with the bit allocation as a starting point, obtain h copies of the frequency spectrum signal within the predetermined frequency band range or the predetermined frequency point range in the audio frequency domain signal as a frequency spectrum signal between the highest frequency point with the bit allocation and the starting frequency point of the preset bandwidth extension frequency band, where h is the positive integer or the positive fraction.

In an embodiment of the present disclosure, a copying manner of the m or h copies of the frequency spectrum signal within the predetermined frequency band range or the predetermined frequency point range in the audio frequency domain signal includes: obtaining the m or h copies of the frequency spectrum signal within the predetermined frequency band range or the predetermined frequency point range in the audio frequency domain signal by repeatedly copying in sequence the frequency spectrum signal within the predetermined frequency band range or the predetermined frequency point range in the audio frequency domain signal; or obtaining the m or h copies of the frequency spectrum signal within the predetermined frequency band range or the predetermined frequency point range in the audio frequency domain signal by mirror-copying multiple times the frequency spectrum signal within the predetermined frequency band range or the predetermined frequency point range in the audio frequency domain signal.

In an embodiment of the present disclosure, a same manner is used between different frames to predict the frequency spectrum signal between the highest frequency point with the bit allocation and the highest frequency point of the preset bandwidth extension frequency band.

In an embodiment of the present disclosure, the apparatus is further configured to: perform a frequency domain envelope correction on a frequency spectrum signal between the highest frequency point with the bit allocation and the starting frequency point of the preset bandwidth extension frequency band.

In an embodiment of the present disclosure, the apparatus is further configured to any one of: correct a frequency domain envelope value of a frequency spectrum signal between the highest frequency point with the bit allocation and an intermediate frequency point between the highest frequency point with the bit allocation and the starting frequency point of the preset bandwidth extension frequency band based on a frequency domain envelope value of a frequency spectrum signal between a first frequency point and the highest frequency point with the bit allocation; and correct a frequency domain envelope value of a frequency spectrum signal between the intermediate frequency point and the starting frequency point of the preset bandwidth extension frequency band based on a frequency domain envelope value of a frequency spectrum signal between the starting frequency point of the preset bandwidth extension frequency band and a second frequency point; in which the first frequency point is: W1−0.5×Wx; W1 represents the highest frequency point with the bit allocation, and Wx represents a frequency bandwidth between the highest frequency point with the bit allocation and the starting frequency point of the preset bandwidth extension frequency band; the second frequency point is: W2+0.5×Wx; and W2 represents the starting frequency point of the preset bandwidth extension frequency band; correct a frequency domain envelope value of the frequency spectrum signal between the highest frequency point with the bit allocation and the starting frequency point of the preset bandwidth extension frequency band based on a frequency domain envelope value of a frequency spectrum signal between a third frequency point and the highest frequency point with the bit allocation; in which the third frequency point is: W1−Wx; or correct a frequency domain envelope value of the frequency spectrum signal between the highest frequency point with the bit allocation and the starting frequency point of the preset bandwidth extension frequency band based on a frequency domain envelope value of a frequency spectrum signal between the starting frequency point of the preset bandwidth extension frequency band and a fourth frequency point; in which the fourth frequency point is: W2+Wx.

In an embodiment of the present disclosure, the apparatus is further configured to: obtain at least one of the frequency domain envelope value of the frequency spectrum signal between the first frequency point and the highest frequency point with the bit allocation, the frequency domain envelope value of the frequency spectrum signal between the starting frequency point of the preset bandwidth extension frequency band and the second frequency point, the frequency domain envelope value of the frequency spectrum signal between the third frequency point and the highest frequency point with the bit allocation, or the frequency domain envelope value of the frequency spectrum signal between the starting frequency point of the preset bandwidth extension frequency band and the fourth frequency point by decoding the bit stream.

In an embodiment of the present disclosure, the apparatus is configured to: perform noise filling on a frequency band between the highest frequency point with the bit allocation and the highest frequency point of the preset bandwidth extension frequency band.

In an embodiment of the present disclosure, the apparatus is further configured to: obtain a reconstructed audio time domain signal by adding and combining the audio frequency domain signal and the frequency spectrum signal between the highest frequency point with the bit allocation and the highest frequency point of the preset bandwidth extension frequency band, and transforming them from a frequency domain to a time domain.

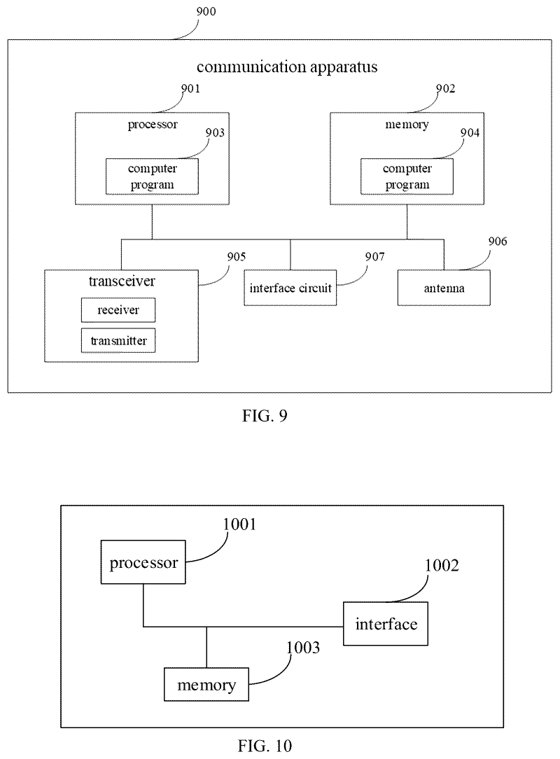

Referring to FIG. 9, FIG. 9 is a schematic block diagram of a communication apparatus 900 according to an embodiment of the present application. The communication apparatus 900 may be a network device or a terminal device, may also be a chip, a chip system, or a processor that supports the network device to implement the above methods, and may also be a chip, a chip system, or a processor that supports the terminal device to implement the above methods. The device may be configured to implement the methods as described in the above method embodiments, and for details thereof, reference may be made to the descriptions in the above method embodiments.

The communication apparatus 900 may include one or more processors 901. The processor 901 may be a general-purpose processor or a special-purpose processor. For example, the processor 901 may be a baseband processor or a central processing unit. The baseband processor may be configured to process a communication protocol and communication data, and the central processing unit may be configured to control a communication apparatus (such as a base station, a baseband chip, the terminal device, a terminal device chip, a DU, a CU, or the like), execute computer programs, and process data of computer programs.

In some examples, the communication apparatus 900 may further include one or more memories 902 having stored therein a computer program 904. The processor 901 executes the computer program 904, to cause the communication apparatus 900 to implement the methods as described in the above method embodiments. In some examples, the memory 902 may have stored therein data. The communication apparatus 900 and the memory 902 may be provided separately or integrated together.

In some examples, the communication apparatus 900 may further include a transceiver 905 and an antenna 906. The transceiver 905 may be called a transceiving element, a transceiving machine, a transceiving circuit or the like, for implementing a transceiving function. The transceiver 905 may include a receiver and a transmitter. The receiver may be called a receiving machine, a receiving circuit or the like, for implementing a receiving function. The transmitter may be called a sending machine, a sending circuit or the like, for implementing a sending function.

In some examples, the communication apparatus 900 may further include one or more interface circuits 907. The interface circuit 907 is configured to receive a code instruction and transmit the code instruction to the processor 901. The processor 901 runs the code instruction to enable the communication apparatus 900 to execute the methods as described in the above method embodiments.

In an implementation, the processor 901 may include the transceiver configured to implement receiving and sending functions. For example, the transceiver may be a transceiving circuit, an interface, or an interface circuit. The transceiving circuit, the interface or the interface circuit configured to implement the receiving and sending functions may be separated or may be integrated together. The above transceiving circuit, interface or interface circuit may be configured to read or write codes/data, or the above transceiving circuit, interface or interface circuit may be configured to transmit or transfer signals.

In an implementation, the processor 901 may have stored therein a computer program 903 that, when running on the processor 901, causes the communication apparatus 900 to implement the methods as described in the above method embodiments. The computer program 903 may be embedded in the processor 901, and in this case, the processor 901 may be implemented by a hardware.

In an implementation, the communication apparatus 900 may include a circuit, and the circuit may implement the sending, receiving or communicating function in the foregoing method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured using various IC process technologies, such as a complementary metal oxide semiconductor (CMOS), a negative metal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus described in the above embodiments may be the network device or the terminal device, but the scope of the communication apparatus described in the present disclosure is not limited thereto, and a structure of the communication apparatus is not limited by FIG. 9. The communication apparatus may be a stand-alone device or may be a part of a larger device. For example, the communication apparatus may be: (1) a stand-alone integrated circuit (IC), or a chip, or a chip system or subsystem; (2) a set of one or more ICs, in which the set of ICs may also include a storage component for storing data and computer programs; (3) an ASIC, such as a modem; (4) a module that may be embedded in other devices; (5) a receiver, a terminal device, an intelligent terminal device, a cellular phone, a wireless device, a handheld machine, a mobile unit, a vehicle device, a network device, a cloud device, an artificial intelligence device, etc.; (6) others.

For the case where the communication apparatus may be a chip or a chip system, reference may be made to a schematic block diagram of the chip shown in FIG. 10. The chip shown in FIG. 10 includes a processor 1001 and an interface 1002. In the chip, one or more processors 1001 may be provided, and more than one interface 1002 may be provided.

In some examples, the chip further includes a memory 1003 for storing necessary computer programs and data.

Those skilled in the art may also understand that various illustrative logical blocks and steps listed in embodiments of the present disclosure may be implemented by an electronic hardware, a computer software, or a combination thereof. Whether such functions are implemented by a hardware or a software depends on specific applications and design requirements of an overall system. For each specific application, those skilled in the art may use various methods to implement the described functions, but such an implementation should not be understood as extending beyond the protection scope of embodiments of the present disclosure.

The present disclosure further provides a readable storage medium having stored thereon instructions that, when executed by a computer, cause functions of any of the above method embodiments to be implemented.

The present disclosure further provides a computer program product that, when executed by a computer, causes functions of any of the above method embodiments to be implemented.

The above embodiments may be implemented in whole or in part by a software, a hardware, a firmware or any combination thereof. When implemented using the software, the above embodiments may be implemented in whole or in part in a form of the computer program product. The computer program product includes one or more computer programs. When the computer program is loaded and executed on the computer, all or some of the processes or functions according to embodiments of the present disclosure will be generated. The computer may be a general purpose computer, a special purpose computer, a computer network, or other programmable devices. The computer program may be stored in a computer-readable storage medium or transmitted from one computer-readable storage medium to another computer-readable storage medium. For example, the computer program may be transmitted from one website, computer, server or data center to another website, computer, server or data center in a wired manner (such as via a coaxial cable, an optical fiber, a digital subscriber line (DSL)) or a wireless manner (such as an infrared manner, a cordless manner, via microwave, or the like). The computer-readable storage medium may be any available medium that can be accessed by the computer, or a data storage device such as the server or the data center integrated with one or more available media. The available medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

Those of ordinary skill in the art can understand that the first, second, and other numeral numbers involved in the present disclosure are distinguished only for convenience of description, and are not intended to limit the scope of embodiments of the present disclosure, and nor are they intended to represent sequential order.

The term “at least one” used in the present disclosure may also be described as one or more, and the term “a plurality of” may cover two, three, four or more, which are not limited in the present disclosure. In embodiments of the present disclosure, for a certain kind of technical feature, the technical features in this kind of technical feature are distinguished by term like “first”, “second”, “third”, “A”, “B”, “C” and “D”, etc., and these technical features described with the “first”, “second”, “third”, “A”, “B”, “C”and “D”have no order of precedence or size.

The correspondence shown in each table in the present disclosure may be configured or predefined. The values of information in each table are just examples, and may be configured as other values, which are not limited in the present disclosure. When configuring a correspondence between the information and various parameters, it is not necessary to configure all the correspondences shown in the tables. For example, the correspondences shown in some rows of the tables in the present disclosure may not be configured. For another example, appropriate variations or adjustments (such as splitting, merging, and so on) can be made based on the above tables. The names of parameters shown in the titles of the above tables may also adopt other names understandable in the communication apparatus, and the values or representations of the parameters may also be other values or representations understandable in the communication apparatus. When the above tables are implemented, other data structures may also be used, for example, arrays, queues, containers, stacks, linear tables, pointers, linked lists, trees, graphs, structural bodies, classes, heaps, or hash tables may be used.

The term “predefinition” in the present disclosure may be understood as definition, predefinition, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such an implementation should not be considered as extending beyond the scope of the present disclosure.

Those skilled in the art can clearly understand that for the convenience and brevity of the description, for the specific working process of the above-described system, device and unit, reference may be made to the corresponding process in the foregoing method embodiments, which will not be repeated here.

The above only describes some specific implementations of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

1. A method for extending a frequency band of an audio signal, performed by a decoding device, comprising:
receiving a bit stream sent by an encoding device, and obtaining a decoded audio frequency domain signal by decoding the bit stream; and
in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, predicting a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

2. The method according to claim 1, further comprising:
determining the starting frequency point and the highest frequency point of the preset bandwidth extension frequency band based on an encoding rate of the encoding device and a frequency band range in the audio signal needing to be encoded.

3. The method according to claim 1, wherein frequency points in the predetermined frequency band range or the predetermined frequency point range are all lower than the highest frequency point with the bit allocation.

4. The method according to claim 1, wherein predicting the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal comprises:
taking the highest frequency point with the bit allocation as a starting point, or taking the highest frequency point of the preset bandwidth extension frequency band as a starting point, sequentially obtaining n copies of the frequency spectrum signal within the predetermined frequency band range or the predetermined frequency point range in the audio frequency domain signal as the frequency spectrum signal between the highest frequency point with the bit allocation and the highest frequency point of the preset bandwidth extension frequency band, where n is a positive integer or a positive fraction.

5. The method according to claim 4, wherein a copying manner of the n copies of the frequency spectrum signal within the predetermined frequency band range or the predetermined frequency point range in the audio frequency domain signal comprises:
obtaining the n copies of the frequency spectrum signal within the predetermined frequency band range or the predetermined frequency point range in the audio frequency domain signal by repeatedly copying in sequence the frequency spectrum signal within the predetermined frequency band range or the predetermined frequency point range in the audio frequency domain signal.

6. The method according to claim 1, wherein predicting the frequency spectrum signal between the highest frequency point with the bit allocation and the highest frequency point of the preset bandwidth extension frequency band based on the frequency spectrum signal within the predetermined frequency band range or the predetermined frequency point range in the audio frequency domain signal comprises:
taking the starting frequency point of the preset bandwidth extension frequency band as a starting point, or taking the highest frequency point of the preset bandwidth extension frequency band as a starting point, obtaining m copies of the frequency spectrum signal within the predetermined frequency band range or the predetermined frequency point range in the audio frequency domain signal as a frequency spectrum signal between the starting frequency point of the preset bandwidth extension frequency band and the highest frequency point of the preset bandwidth extension frequency band, where m is a positive integer or a positive fraction; and
taking the starting frequency point of the preset bandwidth extension frequency band as a starting point, or taking the highest frequency point with the bit allocation as a starting point, obtaining h copies of the frequency spectrum signal within the predetermined frequency band range or the predetermined frequency point range in the audio frequency domain signal as a frequency spectrum signal between the highest frequency point with the bit allocation and the starting frequency point of the preset bandwidth extension frequency band, where h is the positive integer or the positive fraction.

7. The method according to claim 6, wherein
a copying manner of the m or h copies of the frequency spectrum signal within the predetermined frequency band range or the predetermined frequency point range in the audio frequency domain signal comprises:
obtaining the m or h copies of the frequency spectrum signal within the predetermined frequency band range or the predetermined frequency point range in the audio frequency domain signal by repeatedly copying in sequence the frequency spectrum signal within the predetermined frequency band range or the predetermined frequency point range in the audio frequency domain signal.

8. The method according to claim 1, wherein a same manner is used between different frames to predict the frequency spectrum signal between the highest frequency point with the bit allocation and the highest frequency point of the preset bandwidth extension frequency band.

9. The method according to claim 1, further comprising:
performing a frequency domain envelope correction on a frequency spectrum signal between the highest frequency point with the bit allocation and the starting frequency point of the preset bandwidth extension frequency band.

10. The method according to claim 9, wherein performing the frequency domain envelope correction on the frequency spectrum signal between the highest frequency point with the bit allocation and the starting frequency point of the preset bandwidth extension frequency band comprises correcting a frequency domain envelope value of a frequency spectrum signal between the highest frequency point with the bit allocation and an intermediate frequency point between the highest frequency point with the bit allocation and the starting frequency point of the preset bandwidth extension frequency band based on a frequency domain envelope value of a frequency spectrum signal between a first frequency point and the highest frequency point with the bit allocation; and correcting a frequency domain envelope value of a frequency spectrum signal between the intermediate frequency point and the starting frequency point of the preset bandwidth extension frequency band based on a frequency domain envelope value of a frequency spectrum signal between the starting frequency point of the preset bandwidth extension frequency band and a second frequency point; wherein the first frequency point is: W1−0.5×Wx; W1 represents the highest frequency point with the bit allocation, and Wx represents a frequency bandwidth between the highest frequency point with the bit allocation and the starting frequency point of the preset bandwidth extension frequency band; the second frequency point is: W2+0.5×Wx; and W2 represents the starting frequency point of the preset bandwidth extension frequency band.

11. The method according to claim 10, further comprising:
obtaining at least one of the frequency domain envelope value of the frequency spectrum signal between the first frequency point and the highest frequency point with the bit allocation, or the frequency domain envelope value of the frequency spectrum signal between the starting frequency point of the preset bandwidth extension frequency band and the second frequency point by decoding the bit stream.

12. The method according to claim 1, further comprising:
performing noise filling on a frequency band between the highest frequency point with the bit allocation and the highest frequency point of the preset bandwidth extension frequency band.

13. The method according to claim 1, further comprising:
obtaining a reconstructed audio time domain signal by adding and combining the audio frequency domain signal and the frequency spectrum signal between the highest frequency point with the bit allocation and the highest frequency point of the preset bandwidth extension frequency band, and transforming them from a frequency domain to a time domain.

14. (canceled)

15. A communication apparatus, comprising:
a processor; and
a memory having stored therein a computer program executable by the processor,
wherein the processor is configured to:
receive a bit stream sent by an encoding device, and obtain a decoded audio frequency domain signal by decoding the bit stream; and
predict, in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

16. (canceled)

17. A non-transitory computer-readable storage medium having stored therein instructions that, when executed by a processor, cause the processor to perform:
receiving a bit stream sent by an encoding device, and obtaining a decoded audio frequency domain signal by decoding the bit stream; and
in response to a highest frequency point with a bit allocation in the audio frequency domain signal being lower than a starting frequency point of a preset bandwidth extension frequency band, or a frequency band with a bit allocation in the audio frequency domain signal being smaller than a preset bandwidth extension starting frequency band, predicting a frequency spectrum signal between the highest frequency point with the bit allocation and a highest frequency point of the preset bandwidth extension frequency band based on a frequency spectrum signal within a predetermined frequency band range or a predetermined frequency point range in the audio frequency domain signal.

18. The method according to claim 4, wherein a copying manner of the n copies of the frequency spectrum signal within the predetermined frequency band range or the predetermined frequency point range in the audio frequency domain signal comprises:
obtaining the n copies of the frequency spectrum signal within the predetermined frequency band range or the predetermined frequency point range in the audio frequency domain signal by mirror-copying multiple times the frequency spectrum signal within the predetermined frequency band range or the predetermined frequency point range in the audio frequency domain signal.

19. The method according to claim 6, wherein
a copying manner of the m or h copies of the frequency spectrum signal within the predetermined frequency band range or the predetermined frequency point range in the audio frequency domain signal comprises:
obtaining the m or h copies of the frequency spectrum signal within the predetermined frequency band range or the predetermined frequency point range in the audio frequency domain signal by mirror-copying multiple times the frequency spectrum signal within the predetermined frequency band range or the predetermined frequency point range in the audio frequency domain signal.

20. The method according to claim 9, wherein performing the frequency domain envelope correction on the frequency spectrum signal between the highest frequency point with the bit allocation and the starting frequency point of the preset bandwidth extension frequency band comprises:
correcting a frequency domain envelope value of the frequency spectrum signal between the highest frequency point with the bit allocation and the starting frequency point of the preset bandwidth extension frequency band based on a frequency domain envelope value of a frequency spectrum signal between a third frequency point and the highest frequency point with the bit allocation; wherein the third frequency point is: W1−Wx; W1 represents the highest frequency point with the bit allocation, and Wx represents a frequency bandwidth between the highest frequency point with the bit allocation and the starting frequency point of the preset bandwidth extension frequency band.

21. The method according to claim 9, wherein performing the frequency domain envelope correction on the frequency spectrum signal between the highest frequency point with the bit allocation and the starting frequency point of the preset bandwidth extension frequency band comprises:
correcting a frequency domain envelope value of the frequency spectrum signal between the highest frequency point with the bit allocation and the starting frequency point of the preset bandwidth extension frequency band based on a frequency domain envelope value of a frequency spectrum signal between the starting frequency point of the preset bandwidth extension frequency band and a fourth frequency point; wherein the fourth frequency point is: W2+Wx; W2 represents the starting frequency point of the preset bandwidth extension frequency band, and Wx represents a frequency bandwidth between the highest frequency point with the bit allocation and the starting frequency point of the preset bandwidth extension frequency band.

22. The method according to claim 20, further comprising:
obtaining the frequency domain envelope value of the frequency spectrum signal between the third frequency point and the highest frequency point with the bit allocation by decoding the bit stream.
